(19) United States
(12) Patent Application Publication
(10) Pub. No.: US 2022/0414628 A1
(43) Pub. Date: Dec. 29, 2022

(54) METHOD AND SYSTEM OF MANAGING INVOICES FOR INTER-RELATED TRANSACTIONS

(71) Applicant: Sawi Information Technology Co., Ltd., Boston, MA (US)

(72) Inventors: Mohammed ALSAIDI, Dhahran (SA); Abdullah ALSAIDI, Dhahran (SA); Khadija KHARTIT, Norwood, MA (US)

(21) Appl. No.: 17/851,834

(22) Filed: Jun. 28, 2022

Related U.S. Application Data
(60) Provisional application No. 63/216,520, filed on Jun. 29, 2021.

(51) Int. Cl. G06Q 20/14

(52) U.S. Cl. CPC G06Q 20/14

(57) ABSTRACT

The method and system of managing invoices for cashless settlement comprises the steps of receiving business details for the validation, registering the business details after validation, providing one or more user interfaces for the user to upload invoices, transmitting the uploaded invoice details for approval and verification, correlating the uploaded invoice details and determining at least one cashless settlement associated with the invoice, transmitting the settlement details for the information to the associated user(s), and recording the executed settlements.

### FIELD OF INVENTION

The present invention relates to cashless settlements. In particular, the invention relates to a system and method for managing invoices for inter-related transactions among a plurality of enterprises through cashless settlements.

### BACKGROUND

In recent times, the number of transactions among companies has increased atan outstanding speed. Corresponding to such increased transactions, the inter-company settlement relations have also become complicated. Conventionally, most inter-companies have preferred all the transactions to be paid in cash via ACH, checks, or wire transfers. In instances where companies need to pay for each transaction, they do so with fiat money and transact with multiple cash payments between every two companies. These multiple cash payments can be avoided using an improved system that is able to, systematically and conveniently, implement settlement procedures among many companies connected through a series of vendor/client relationships.

Thus, there is a need for a system that includes a. centralized network for connecting business entities via inter-related invoices, and where a simple cashless settlement among the business entities can be facilitated by tracking the source and destination points of the invoice.

### OBJECT OF THE INVENTION

The primary object of the present invention is to provide a system and a method of automated tracking and connecting invoices among inter-related parties for one or more cashless settlements.

Another object of the present invention is to provide a system that is cost-effective, fast, efficient, which reduces the monotonous tasks of cash transactions management and reconciliation among various enterprises connected through a loop of invoices.

### SUMMARY

Various embodiments of the present disclosure provide methods and systems for efficiently capturing, tracking, processing, and managing invoices of inter-related transactions among a plurality of enterprises.

In an embodiment, a computer-implemented method for managing invoices of inter-related business transactions is disclosed. The method by the processor includes receiving one or more invoices in association with the payment for at least one business transaction, extracting data from the one or more invoices, determining, at least one inter-related transaction among the participating parties, wherein the participating parties are one or more enterprises involved in the payment of the at least one business transaction, generating one or more cashless settlement paths, and selecting, by the processor, an optimal settlement path for settling the at least one invoice. The method further includes determining, by the processor of at least one payer and at least one payee, wherein the at least one payer and at least one payee are one or more enterprises involved in a business transaction and determining, by the processor, at least one directional invoice loop by connecting the related payer and the payee for a potential cashless settlement. The method includes determining by the processor, the validity of an invoice, by receiving the approval from the payer for the invoice and the verification from the payee for the same invoice prior to the listing of the specific invoice. The method includes generating reports for each cashless settlement, or the payment associated with each invoice and transmitting the summarized information as an electronic receipt to the one or more users involved in the related business transactions.

In another embodiment, an application server for managing invoices of inter-related business transactions, among a plurality of enterprises, is disclosed. The application server includes a communication interface, a memory storing executable instructions, and a processor operatively coupled with the communication interface and the memory. The processor is configured to execute the executable instructions to cause the application server to receive one or more invoices in association with the payment for at least one business transaction, extract data from the one or more invoices, determine at least one inter-related transaction among the participating parties, wherein the participating parties are one or more enterprises involved in the payment of the at least one business transaction, generate one or more cashless settlement paths, and select an optimal settlement path for settling the at least one invoice. The processor is further configured to determine at least one payer and at least one payee, wherein the at least one payer and at least one payee are one or more enterprises involved in a business transaction and determine at least one directional invoice loop by connecting the related payer and the payee for a potential cashless settlement. Further, the processor is configured to determine the validity of an invoice by receiving the approval from the payer to approve an invoice and the verification from the payee to verify the invoice prior to the listing of the related invoice. The processor is configured to generate reports for each cashless settlement, or the payment associated with each invoice and transmit the summarized information as an electronic receipt to the one or more users involved in the related business transactions.

### BRIEF DESCRIPTION OF THE DRAWINGS:

The following detailed description of illustrative embodiments is better understood when read in conjunction with the appended drawings. For the purpose of illustrating the present disclosure, exemplary constructions of the disclosure are shown in the drawings. However, the present disclosure is not limited to a specific device or a tool and instrumentalities disclosed herein. Moreover, those in the art will understand that the drawings are not to scale. Wherever possible, like elements have been indicated by identical numbers:

FIG. 1 illustrates an example representation of an environment related to at least some example embodiments of the present disclosure;

FIG. 2 is a simplified block diagram of a server system, in accordance with an embodiment of the present disclosure;

FIG. 3 shows an example representation of a UI displayed for the onboarding process, in accordance with an example embodiment of the present disclosure;

FIG. 4 shows an example representation of a UI for receiving the invoices, in accordance with an example embodiment of the present disclosure;

FIG. 5 shows an example representation of a UI for the listing of invoices, in accordance with an example embodiment of the present disclosure;

FIG. 6A, shows an example representation of a UI depicted to display an uploaded invoice for verification to the payee, in accordance with an example embodiment of the present disclosure;

FIG. 6B, shows an example representation of a UI depicted to display an uploaded invoice for approval from the payer to approve, in accordance with an example embodiment of the present disclosure;

FIG. 7 is a flowchart illustrating an example method, according to one embodiment; and

FIG. 8 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. However, it will be apparent to one skilled in the art that the present disclosure can be practiced without these specific details. Descriptions of well-known components and processing techniques are omitted to not obscure the embodiments herein unnecessarily. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described, which may be exhibited by some embodiments and not by others. Similarly, various requirements are described, which may be requirements for some embodiments but not for other embodiments.

Moreover, although the following description contains many specifics for the purposes of illustration, anyone skilled in the art will appreciate that many variations and/or alterations to the said details are within the scope of the present disclosure. Similarly, although many of the features of the present disclosure are described in terms of each other or in conjunction with each other, one skilled in the art will appreciate that many of these features can be provided independently of other features. Accordingly, this description of the present disclosure is set forth without any loss of generality to and without imposing limitations upon the present disclosure.

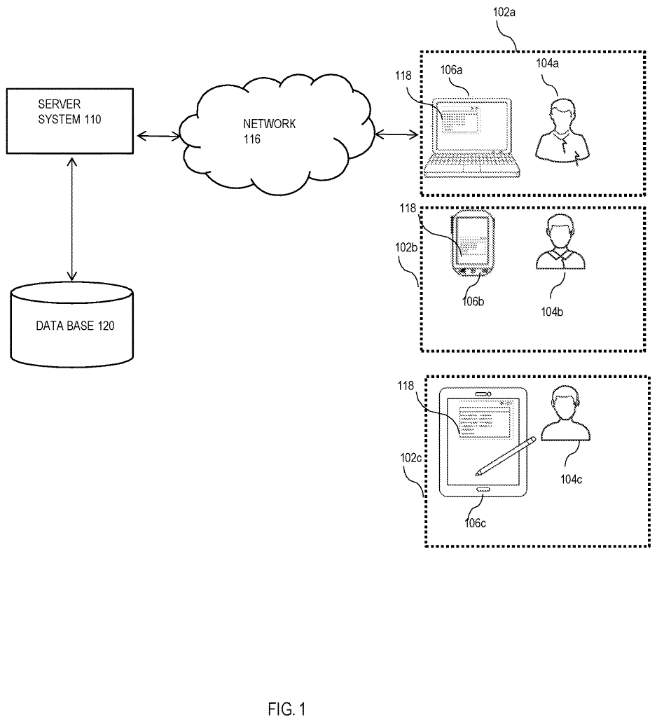

Various embodiments of the present invention are described hereinafter with reference to FIG. 1 to FIG. 9.

FIG. 1 illustrates an example representation of an environment 100 related to at least some example embodiments of the present disclosure. Although the environment 100 is presented in one arrangement, other arrangements are also possible where the parts of the environment 100 (or other parts) are arranged or interconnected differently. The environment 100 is depicted to include one or more enterprises 102. The term ‘enterprise’ as used herein may refer to a worksite, a business entity, an industry, any corporate company, a public or private sector enterprise, and the like.

The enterprise 102 is depicted to include at least one enterprise exemplarily depicted as an enterprise 102a, an enterprise 102b and an enterprise 102c. The enterprise 102 is further depicted to include at least one user 104 exemplarily depicted as a user 104a, a user 104b, and a user 104c. The at least one user 104 may be a representative of each enterprise 102. For instance, the user 104a may be an employee admin (e.g. payee) of the enterprise 102a, and the user 104b maybe a manager (e.g. payer) of the enterprise 102b and the user 104c may be a supervisor of the workplace enterprise 102c. For illustration purposes, only three users are shown for explaining the embodiments of the present disclosure, and there can be any number of users. The users 104a-104c representing the enterprises 106a-106c respectively, are hereinafter interchangeably referred to as ‘the payee’ or ‘the payer,’ based on the status of transaction associated with an invoice.

Further, the users 104a and 104b are associated with respective user devices such as a user device 106a, a user device 106b, and a user device 106c, respectively. The user devices 106a-106c associated with the users 104a-104c are exemplarily depicted to be a tablet computer, a laptop and a computer, respectively. The user devices 106a-106c are capable of connecting to a communication network, such as a network 116, for communicating with each other, and the user devices 106a-106c may be embodied as any electronic device capable of facilitating communication with external entities. Some non-limiting examples of the electronic device may include a laptop computer, a smartphone, a desktop computer, a workstation terminal, a personal digital assistant, a wearable device, or in general, any computing device capable of Web access. The network 116 may include wired networks, wireless networks, and combinations thereof. Some non-limiting examples of the wired networks may include Ethernet, local area networks (LANs), fiber-optic networks, and the like. Some non-limiting examples of wireless networks may include cellular networks like GSM/3G/4G/5G/LTE/CDMA networks, wireless LANs, Bluetooth, Wi-Fi or ZigBee networks, and the like. An example of a combination of wired and wireless networks may include the Internet.

In one embodiment, the user devices 106a-106c are equipped with an instance of a cashless settlement application 118 (hereinafter interchangeably referred to as ‘the application 118.’) The application 118 is a set of computer-executable codes configured to provide user interfaces (Uls) to the users 104a-104c for tracking, processing, and managing one or more cash settlements associated with each of the invoices for interrelated transactions among a plurality of enterprises 106a-106c, which will be explained further in detail. The application 118 may be hosted and managed by an application server 110.

In an embodiment, the application server 110 may provide the application 118 in response to a request received from each of the user devices 106a-106c via the network 116. In another embodiment, the application 118 may be factory-installed on the user devices 106a-106c. In some embodiments, the application server 110 may provide application services as a web service accessible through a website. In such a scenario, the application 118 may be accessed through the website over the network 116 using web browser applications installed in the user device (e.g. the user device 106a).

In addition, the application server 110 should be understood to be embodied in at least one computing device in communication with the network 116, which may be specifically configured, via executable instructions, to perform as described herein, and/or embodied in at least one non-transitory computer-readable media.

In the illustrative embodiment, the application server 110 collects the information necessary to identify and validate the enterprise and apply access rules as deemed acceptable while onboarding or at another appropriate time. After successful onboarding, the application server 110 enables the user 104 representing the enterprise 102 to upload one or more invoices in association with a payment for a business transaction.

In an alternative embodiment, the application server 110 embodied in a device is configured to create profiles for the enterprise and manage the invoices associated with the profiles. The application server 110 is configured to extract the invoice data of one or more invoices (e.g. invoice receipts). The extracted data is processed by the application server 110 to track each invoice to determine at least one inter-related transaction among the participating parties, wherein the participating parties are one or more enterprises involved in the payment of at least one business transaction.

Based on the tracked information, the application server 110 determines at least one payer and at least one payee, wherein the at least one payer and at least one payee are one or more enterprises involved in a business transaction and application server 110 then determines at least one directional invoice loop by connecting the related payer and the payee for potential a cashless settlement.

The application server 110 generates one or more cashless settlement paths by comparing and computing a balance amount for each set of payees in the invoice loop to determine one or more cashless settlements for settling at least one invoice. Wherein the payment for invoice comprises one or more of at least one cashless settlement and at least part cash payment.

The application server 110 selects an optimal settlement path for settling at least a part payment of at least one invoice through one or more settlements based on the highest common value determined from the balance amount and which includes the highest number of cashless settlements that fully or partially settle the payment of at least one invoice.

The application server 110 determines the validity of an invoice by receiving an approval from the payer to approve an invoice and a verification from the payee to verify the invoice prior to listing of the invoice, after successful approval and verification the application server 110 lists the invoice as a valid invoice, wherein the invoice is considered eligible for payment and settlement.

The application server 110 is configured to facilitate receipt of at least a part payment for the invoice. The payer (e.g. user 104a) may make part payments using debit cards, credit cards, e-wallets, bank transfers, electronic cheques, mobile credit, bitcoin, etc.

The application server 110 is configured to record the progress or updates after the execution of at least one cashless settlement associated with at least one invoice. The application server 110 is further configured to determine and track the payment status of the transactions that are not fully settled through one or more cashless settlements.

The application server 110 generates reports for each cashless settlement or the payment associated with each invoice and transmits the summarized information as an electronic invoice to the one or more users involved in the business transaction.

In an exemplary scenario, if a user 104a representing the enterprise 102a owes or shares an invoice payment of “10000/−” to user 104b representing the enterprise 102b. Further, the user 104b owes an invoice payment of “10000/−” to user 104c representing enterprise 102c and in turn user 104c owes an invoice payment of “10000/−” to the user 104a. Then, the application server 110 tracks each invoice and determines the respective payer and the payee of the transaction, e.g. in the first transaction the payer is the user 104a and the payee is 104b. In this case, the application server 110 determines the invoice loop between the users 104a, 104b and 104c, then determines the balance amount of the transactions as “0” amount for the transactions in the settlement path, thereby settling the invoice without any additional steps of individual payment among each user.

In an exemplary scenario, if a user 104a representing the enterprise 102a owes or shares an invoice payment of “10000/−” to user 104b representing the enterprise 102b, hereafter referred to as transaction 1. Further, the user 104b owes an invoice payment of “5000/−” to user 104c representing enterprise 102c, hereafter referred to as transaction 2, and in turn user 104c owes an invoice payment of “3000/−” to the user 104a, hereafter referred to as transaction 3. Then, the application server 110 tracks each invoice and determines the respective payer and the payee of the transaction, e.g. in the first transaction the payer is the user 104a and the payee is 104b. In this case, the application server 110 determines the invoice loop between the users 104a, 104b and 104c, then determines the highest common value as “3000/−” balance amount of the transaction 1 as “7000/−” amount, transaction 2 as “2000/−” and transaction three as “0” for the transactions in the settlement path, thereby settling the transaction 1 invoice with “3000/−” as cashless settlement and “7000/−” as cash payment or alternate cashless settlements, transaction 2 invoice with “3000/−” as cashless settlement and “2000/−” as a cash payment or alternate cashless settlements and transaction 3 with the cashless settlement of “3000/−” respectively.

The number and arrangement of systems, devices, and/or networks shown in FIG. 1 are provided as an example. There may be other systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g. one or more systems) or a set of devices (e.g. one or more devices) of the environment 100 may perform one or more functions described as being performed by another set of systems or another set of devices of the environment 100.

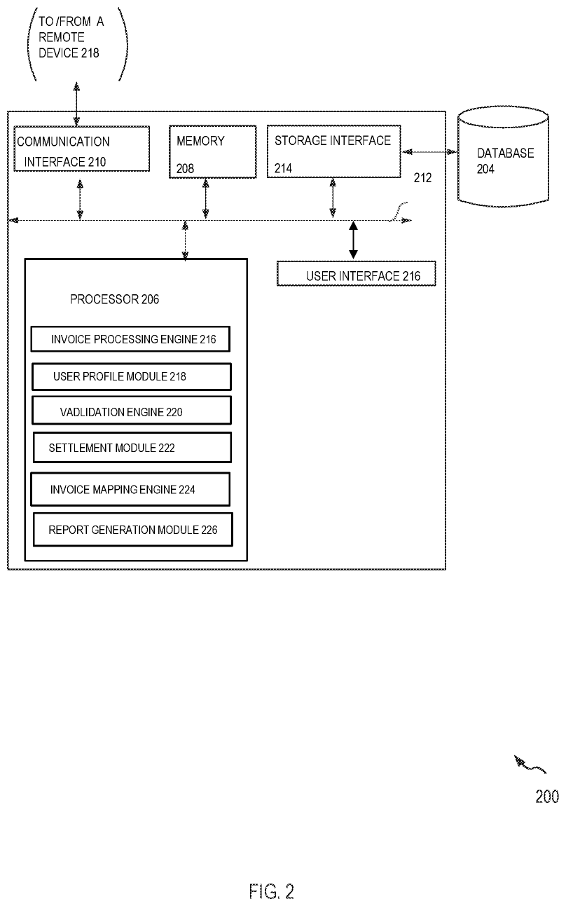

FIG. 2 illustrates a simplified block diagram of an application server 200 used for tracking, processing, and managing the invoices associated with inter-related transactions among a plurality of enterprises 102, in accordance with one embodiment of the present disclosure. Examples of the application server 200 include but are not limited to the application server 110 as shown in FIG. 1.

The application server 200 includes a computer system 202 and a database 204. The computer system 202 includes at least one processor 206 for executing instructions, a memory 208, a communication interface 210, and a storage interface 214. The one or more components of the computer system 202 communicate with each other via a bus 212.

In some embodiments, the database 204 is integrated within the computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In some example embodiments, the database 204 is configured to store invoice and transaction related information, such as, invoice date, invoice status evidence records, transaction information, cashless transaction and user profiles (i.e. enterprises, users).

Examples of the processor 206 include, but are not limited to an application┐ specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the processor 206 is capable of communicating with user interface 216 and a remote device 218 such as, the user devices 106a-106c, or communicating with any entity connected to the networks 116 (as shown in FIG. 1).

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

The components of the application server 200 provided herein may not be exhaustive, and the application server 200 may include more or fewer components than those depicted in FIG. 2. Further, two or more components may be embodied in one single component, and/or one component may be configured using multiple sub-components to achieve the desired functionalities.

In one embodiment, the processor 206 includes an invoice processing engine 216, a user profile management engine 218, a validation engine 220, a settlement module 222, an invoice mapping engine 224 and a report generation engine 226. As such, the one or more components of the processor 206 as described above are communicably coupled with the application 118 and configured for tracking, processing, and managing one or more cash settlements associated with each of the invoices for interrelated transactions among a plurality of enterprises.

The invoice processing engine 216 includes a suitable logic and/or interface for processing the invoices received and extracts relevant invoice information from the invoices. As explained above, the user 104a-104c may upload invoices at suitable times after onboarding of the enterprise information. The user 104a-104c associated with the user device 106a-106c accesses the application 118 for uploading the invoices in the application 118. In an example scenario, the invoices submitted by the user 104a-104c may be in any tangible form (e.g. scanned billing receipts, electronic documents, etc.)

The user profile management engine 218 includes a suitable logic and/or interface for creating and managing user profiles of each of the users 104a-104c and the enterprises 106a-106c. Specifically, the user profile management engine 218 receives the first and second set of data attributes such as but are not limited to name, email, contact details, position and the like in the application 118. In addition, the user profile management engine 218 is configured to track the invoices submitted by each of the users 104a-104c.

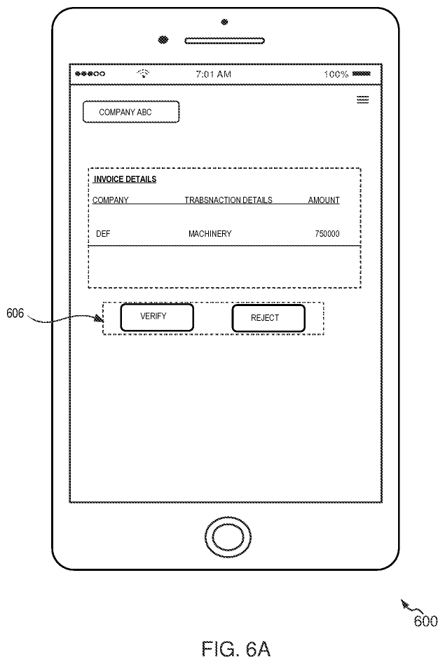

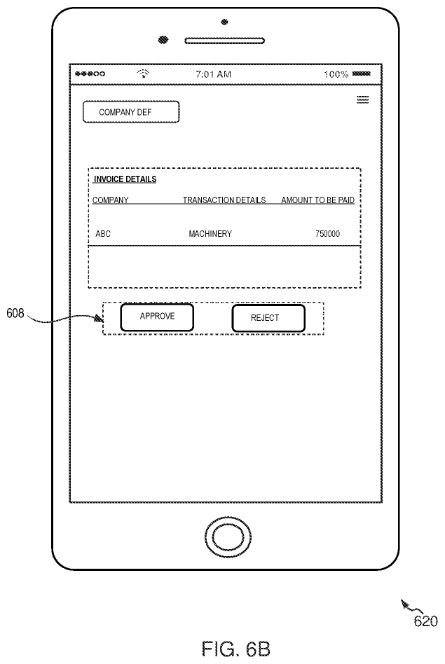

The validation engine 220 includes suitable logic and/or interfaces for validating an invoice submitted by the user 104a-104c. Validation is performed to determine the accuracy of the invoice prior to the display or listing of the invoice. The validation engine 220 is configured to receive approval from the payer (e.g. user 104b) to approve an invoice and a verification from the payee (e.g. user 104a) to verify the invoice. In an exemplary scenario, the payer is rendered with a user interface (as shown in FIG. 6A) in the application 118 for allowing the payer to approve or reject the invoice and the payee is rendered with a user interface (as shown in FIG. 6B) in the application 118 for allowing the payee to verify the invoice.

The invoice mapping engine 224 includes a suitable logic and/or interface for tracking each invoice and correlating the invoices with the existing transactions'information stored in the database 204. The invoice mapping engine 224 is configured to determine at least one payer and at least one payee associated with the submitted valid invoices, wherein the at least one payer and at least one payee may be one or more users representing respective enterprises involved in a business transaction and application server 110 then determines directional invoice loop by connecting the related payer and the payee for a cashless settlement.

The settlement module 222 includes a suitable logic and/or interface for generating settlement paths if the invoice mapping engine 224 any overlap of payment among the enterprises involved in the business transaction. Wherein, the settlement module 222 generates settlement paths by comparing and computing a balance amount for each invoice to be paid by the payees (e.g. enterprises) in the invoice loop to recommend one or more cashless settlements. The settlement module 222 selects an optimal settlement path based on the highest common value determined from the balance amount and which includes highest number cashless settlements that fully or partially settle the payment of the invoice.

The settlement module 222 is further configured to record the progress or updates after the execution of at least one cashless settlement associated with at least one invoice. The settlement module 222 further determines and tracks the payment status for the transactions where the amount of the invoice is not fully settled through one or more cashless settlements. The settlement module 222 is configured to facilitate receipt of at least a part payment for the invoice. The payer (e.g., user 104b) may make part payments using debit cards, credit cards, e-wallets, bank transfers, electronic cheques, mobile credit, bitcoin, etc.

The settlement module 222 records the transaction code that uniquely identifies the settled transaction, the date on which the transaction was performed, the companies and the invoices involved, and the amount and details of each cashless settlement. When the payment is fully received for an invoice the status of the invoice is stored as complete, wherein the payment, comprises one or more of at least one cashless settlement and at least a part of cash payment, the settlement module accordingly updates and stores the status.

The report generation engine 220 includes a suitable logic and/or interface for generating and transmitting a report to at least one user. The report generation engine 220 generates reports for each cashless settlement or the payment associated with each invoice. The report generation engine 220 transmits the summarized information of the electronic invoice according to the settlement or payment to the users involved in the business transaction. For instance, the report generated may be circulated in the form of an attachment (either in an excel format or a pdf format) to the email address of the users. Additionally, the report may provide the contact details of the users involved in the cashless settlement transaction. In this scenario, the report generation engine 220 transmits the report to the users at the desired frequency (either weekly or monthly), for enabling the users to access and track the invoices The report generation engine 220 may indicate each cashless settlement associated with each of the invoices in the application 118 through a color-coding system.

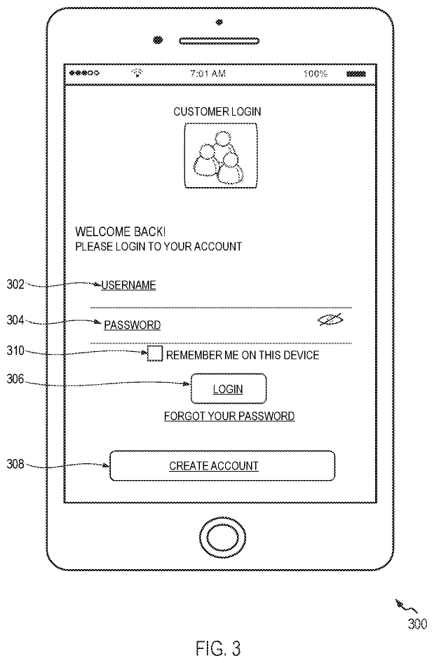

Referring to FIG. 3, an exemplary representation of a user interface (UI) 300 displaying a login page is illustrated, in accordance with an example embodiment of the present disclosure. The UI 300 is depicted by the application 118 upon accessing the application 118 in the user device 106a-106c. As shown, the UI 300 is depicted to include an input field 302 and an input field 304 for receiving login credentials such as an email address and a password, respectively. It is to be understood that the user 104a-104c should undergo a one-time registration process in the application 118 by providing details such as the email address, name, and the like. The user 104a-104c may register for the application 118 by providing input on a button 308 associated with the text ‘CREATE ACCOUNT’. In an embodiment, the user 104a-104c associated with the enterprise 102a-102c may register for the application H8 as an onboarding process for providing the necessary business information.

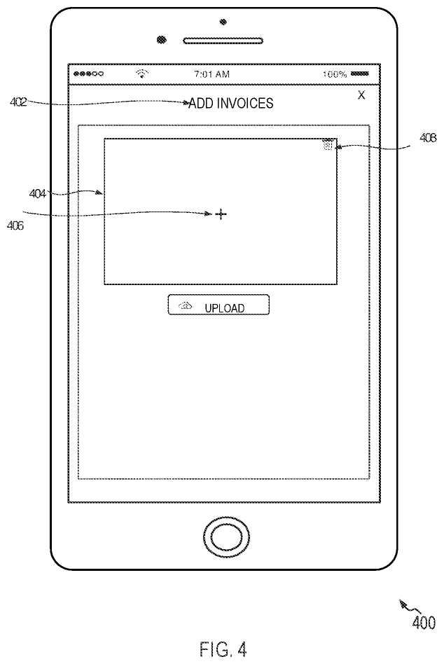

Referring to FIG. 4, an example representation of a UI 400 for capturing the invoices is illustrated. The UI 400 is rendered by the application 118 at the user device 106a-106c based on the selection of an option associated with uploading the invoices in the application 118. The user (e.g., user 104a) uploads the invoice in the application by providing input on an actionable icon 406 (depicted in each image data field 404). Further, the user (e.g., user 104a) may delete the uploaded invoice by providing input on an actionable icon 408. Based on providing input on the button 406, the user (e.g., user 104a) may be directed to a UI for selecting the file or documents from a local storage of the user device (e.g., user device 106a).

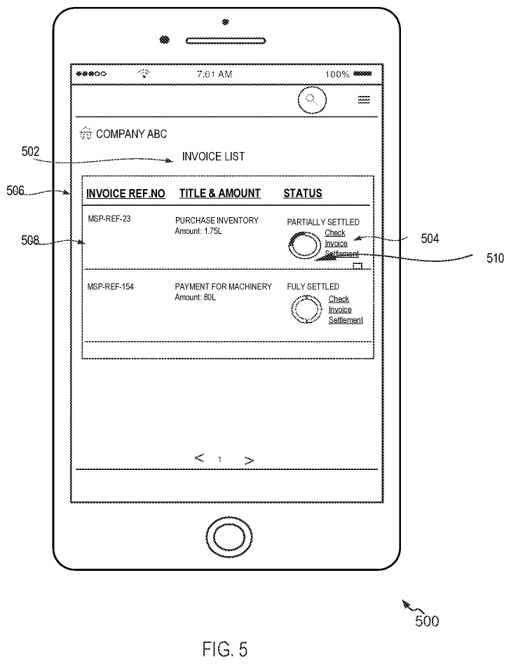

As shown in FIG. 5, the UI 500 is depicted to include a list of invoices 506 stored in the invoice list 502. The list of invoices 506 refers to the invoices that are previously submitted and stored in the application 118. It should be noted that relevant invoice information 508 is depicted for each invoice from the list of invoices 506. The relevant information 508 corresponds to one of the invoice creation date, the invoice settlement details and invoice details. The user may check the settlement progress of the invoice through an indicator 510. The user may access all the details of the settlement by providing an input on the actionable link 504. In other words, the admin 104a may be provided with a UI depicting a list of cashless settlement and the payment transactions that are associated with the invoice.

As shown in FIG. 6A, the UI 600 is depicted to display an uploaded invoice for verification to the payee, the payee can submit the verification or rejection of the invoice by providing input on an actionable icon 606. As shown in FIG. 6B, the UI 620 is depicted to display an uploaded invoice for verification to the payee, the payee can submit the approval or rejection by providing input on an actionable icon 608.

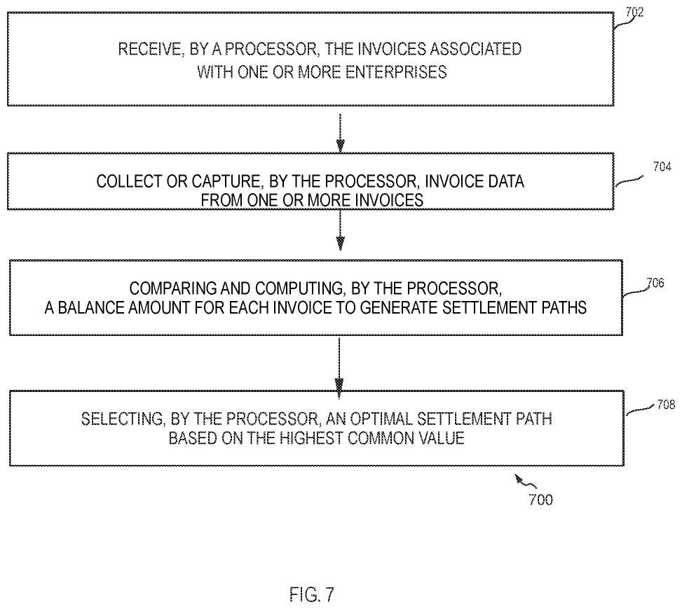

FIG. 7 illustrates a flow diagram of a computer-implemented method 700 for tracking, processing, and managing the invoices associated with inter-related transactions among a plurality of enterprises, in accordance with an embodiment of the present disclosure. The method 700 depicted in the flow diagram may be executed by, for example, the processor 206 of the application server 200. Operations of the flow diagram of the method 700, and combinations of operations in the flow diagram of the method 700, maybe implemented by, for example, hardware, firmware, a processor, circuitry, and/or a different device associated with the execution of software that includes one or more computer program instructions. It is noted that the operations of the method 700 can be described and/or practiced by using a system other than these server systems. The method 700 starts at operation 702.

At operation 702, the method 700 includes receiving, by a processor, the invoices associated with at least one enterprise related to a business transaction using an application available in a user device associated with the user representing the enterprise.

At operation 704, the method 700 includes extracting, by the processor, invoice data from one or more invoices to track each of the invoices for determining at least one inter-related transaction among the participating parties, wherein the participating parties are one or more enterprises involved in the payment of at least one business transaction.

At operation 706, the method 700 includes generating one or more cashless settlement paths, by the processor, by comparing and computing a balance amount for each invoice to be paid by the payees (e.g. enterprises) in the invoice loop to recommend one or more cashless settlements.

At operation 708, the method 700 includes selecting, by the processor, an optimal settlement path based on the highest common value and which includes highest number cashless settlements that fully or partially settle the payment of an invoice.

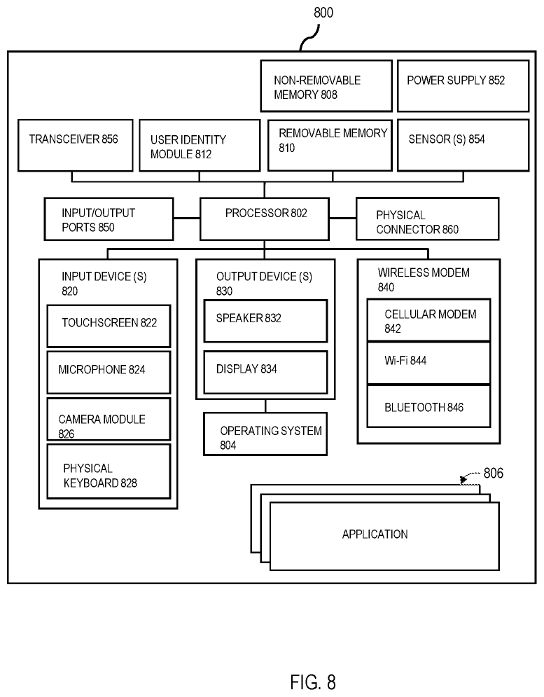

FIG. 8 is a simplified block diagram of an electronic device 800 capable of implementing various embodiments of the present disclosure. For example, the electronic device 800 may correspond to the user devices 106a-106c of FIG. 1. The electronic device 800 is depicted to include one or more applications 806. For example, the one or more applications 806 may include the application 118 of FIG. 1. The application 118 can be an instance of a document management application provided by the application server 110 or the application server 200. One of the one or more applications 806 installed on the electronic device 800 are capable of communicating with an application server system for tracking, processing, and managing the invoices associated with inter related transactions among plurality of enterprises .

It should be understood that the electronic device 800 as illustrated and hereinafter described is merely illustrative of one type of device and should not be taken to limit the scope of the embodiments. As such, it should be appreciated that at least some of the components described below in connection with the electronic device 800 may be optional and thus in an embodiment may include more, less or different components than those described in connection with the embodiment of the FIG. 8. As such, among other examples, the electronic device 800 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 800 includes a controller or a processor 802 (e.g. a signal processor, microprocessor, ASIC, or other control and processing logic circuitry) for performing such tasks as signal coding, data processing, image processing, input/output processing, power control, and/or other functions. An operating system 804 controls the allocation and usage of the components of the electronic device 800 and supports for one or more operations of the application (see, the applications 806), such as the application 118 that implements one or more of the innovative features described herein. In addition, the applications 806 may include common mobile computing applications (e.g., telephony applications, email applications, calendars, contact managers, web browsers, messaging applications) or any other computing application.

The illustrated electronic device 800 includes one or more memory components, for example, a non-removable memory 808 and/or removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM).

The one or more memory components can be used for storing data and/or code for running the operating system 804 and the applications 806. The electronic device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g. capable of capturing voice input), a camera module 826 (e.g. capable of capturing still picture images and/or video images) and a physical keyboard 828. Examples of the output devices 830 may include, but are not limited to a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the electronic device 800 and a public switched telephone network (PSTN).

The electronic device 800 can further include one or more input/output ports 850, a power supply 852, one or more sensors 854 for example, an accelerometer, a gyroscope, a compass, or an infrared proximity sensor for detecting the orientation or motion of the electronic device 800 and biometric sensors for scanning biometric identity of an authorized user, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

The disclosed method with reference to FIG. 7, or one or more operations of the application server 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components)) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the application server 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for managing invoices of inter-related business transactions, the method comprising:
receiving, by a processor, one or more invoices in association with payment for at least one business transaction;
extracting, by the processor, invoice data from the one or more invoices;
determining, by the processor, at least one inter-related transaction among the participating parties, wherein the participating parties are one or more enterprises involved in the payment of the at least one business transaction;
generating, by the processor, one or more cashless settlement paths; and
selecting, by the processor, an optimal settlement path for settling at least a part payment the at least one invoice through the determined one or more cashless settlements.

2. The computer-implemented method as claimed in claim 1, wherein the one or more invoices are uploaded by at least one user representing an enterprise involved in the business transaction.

3. The computer-implemented method as claimed in claim 1, further comprising:
determining, by the processor at least one payer and at least one payee, wherein the at least one payer and at least one payee are one or more enterprises involved in a business transaction; and
determining, by the processor at least one directional invoice loop by connecting the related payer and the payee for a potential cashless settlement.

4. The computer-implemented method as claimed in claim 1, wherein the one or more cashless settlement paths are generated by comparing and computing a balance amount for each set of payees in the invoice loop to determine one or more cashless settlements for settling the at least one invoice.

5. The computer-implemented method as claimed in claim 1, wherein the optimal cashless settlement path is selected based on a highest common value determined from the balance amount and which includes the highest number cashless settlements that at least in part settle the payment of the at least one invoice.

6. The computer-implemented method as claimed in claim 1, further comprising: determining, by the processor, the validity of an invoice by receiving approval from the payer to approve an invoice and a verification from the payee to verify the invoice prior to the listing of the invoice.

7. The computer-implemented method as claimed in claim 1, further comprising: collecting, by the processor, the information necessary to identify and validate at least one enterprise during onboarding.

8. The computer-implemented method as claimed in claim 1, further comprising: generating, by the processor, reports for each cashless settlement or the payment associated with each invoice and transmit the summarized information as an electronic invoice to the one or more users involved in the business transaction.

9. The computer-implemented method as claimed in claim 1, further comprising:
recording, by the processor the progress or updates after execution of at least one cashless settlement associated with at least one invoice;
tracking, by the processor, the payment status of the transactions that are not fully settled through one or more cashless settlements.

10. The computer-implemented method as claimed in claim 1, wherein the payment of the at least one invoice comprises one or more of:
at least one cashless settlement; and
at least part cash payment.

11. An application server for managing invoices of inter-related business transactions, the application server comprising:
a communication interface;
a memory storing executable instructions; and
a processor operatively coupled with the communication interface and the memory, the processor configured to execute the executable instructions to cause the application server to at least:
receive one or more invoices in association with payment for at least one business transaction;
extract invoice data from the one or more invoices;
determine at least one inter-related transaction among the participating parties, wherein the participating parties are one or more enterprises involved in the payment of the at least one business transaction;
generate one or more cashless settlement paths; and
select an optimal settlement path for settling at least a part payment the at least one invoice through the determined one or more cashless settlements.

12. The application server as claimed in claim 11, wherein the one or more invoices are uploaded by at least one user representing an enterprise involved in the business transaction.

13. The application server as claimed in claim 11, wherein the application server is further caused to:
determine at least one payer and at least one payee, wherein the at least one payer and at least one payee are one or more enterprises involved in a business transaction; and
determine at least one directional invoice loop by connecting the related payer and the payee for a potential cashless settlement.

14. The application server as claimed in claim 11, wherein the one or more cashless settlement paths are generated by comparing and computing a balance amount for each set of payees in the invoice loop to determine one or more cashless settlements for settling the at least one invoice.

15. The application server as claimed in claim 11, wherein the optimal cashless settlement path is selected based on a highest common value determined from the balance amount and which includes the highest number cashless settlements that fully or partially settle the payment of the at least one invoice.

16. The application server as claimed in claim 11, wherein the application server is further caused to:
determine the validity of an invoice by receiving approval from the payer to approve an invoice and a verification from the payee to verify the invoice prior to the listing of the invoice.

17. The application server as claimed in claim 11, wherein the application server is further caused to: collect the information necessary to identify and validate at least one enterprise during onboarding.

18. The application server as claimed in claim 11, wherein the application server is further caused to: generate reports for each cashless settlement or the payment associated with each invoice and transmits the summarized information as an electronic invoice to the one or more users involved in the business transaction.

19. The application server as claimed in claim 11, wherein the application server is further caused to:
record the progress or updates after execution of at least one cashless settlement associated with at least one invoice; and
track the payment status of the transactions that are not fully settled through one or more cashless settlements.

20. The application server as claimed in claim 11, wherein the payment of the at least one invoice comprises one or more of:
at least one cashless settlement; and
at least part cash payment.
